(19) United States
(12) Patent Application Publication
(10) Pub. No.: US 2010/0113199 A1
(43) Pub. Date: May 6, 2010

(54) TOOTHED BELT TENSIONER WITH INCREASED DAMPING FORCE

(75) Inventor: Rainer Pflug, Heilsbronn (DE)

Correspondence Address: VOLPE AND KOENIG, P.C., UNITED PLAZA, SUITE 1600, 30 SOUTH 17TH STREET, PHILADELPHIA, PA, 19103, US

(73) Assignee: SCHAEFFLER KG, Herzogenaurach (DE)

(21) Appl. No.: 12/564,289

(22) Filed: Sep. 22, 2009

Related U.S. Application Data
(60) Provisional application No. 61/119,104, filed on Dec. 2, 2008.

(30) Foreign Application Priority Data
Nov. 5, 2008 (DE) 102008056020.0

(51) Int. Cl. F16H 7/12; F16H 7/10

(52) U.S. Cl. 474/112

(57) ABSTRACT

A mechanical tensioning system (1) acting according to an eccentric principle for a traction mechanism of a traction mechanism drive of an internal combustion engine. The tensioning system (1) includes a cylindrical carrier element (8) allocated to a base plate (13) with a longitudinal borehole (12), wherein a fastening screw is guided by this borehole. An eccentric bushing (7) is supported on the carrier element (8) so that it can rotate by a sliding bearing (11). A leg-less, outwards opening, spreading torsion spring (14) arranged between a stationary component of the tensioning system (1) and the eccentric bushing (7) charges the eccentric bushing (7) into a position pretensioning the traction mechanism. A track roller (2) is arranged on the eccentric bushing (7) so that it can rotate by a roller bearing (4). The torsion spring (14) is supported by a spring end on a cup packing (16) that is allocated to a base plate (13) and that is divided and that can move to a limited extent in the radial direction and that forms at least partially a right-angled leg (18). For forming a damping device (15), the eccentric bushing (7) includes at least locally a projection (17) that projects in the axial direction and that encloses the torsion spring (14) and that interacts with the leg (18) of the cup packing (16), wherein the projection (17) encloses an inner friction surface and the leg (18) encloses an outer friction surface.

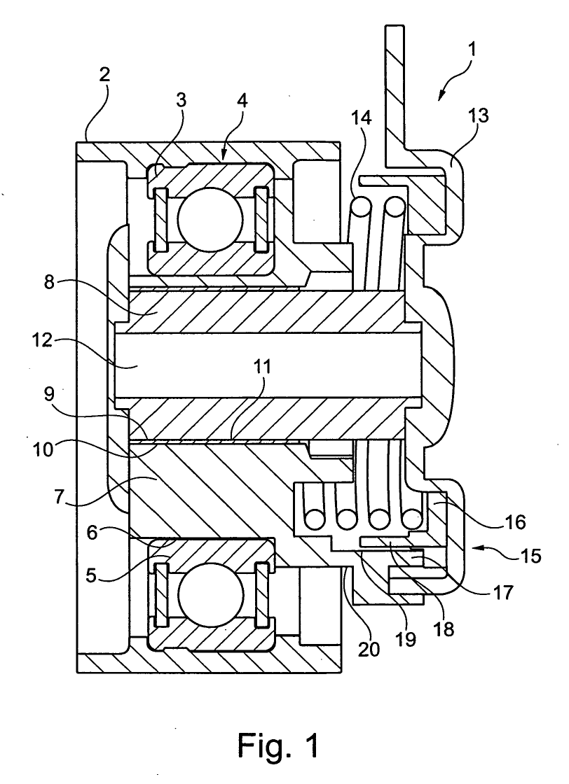

### CROSS-REFERENCE TO RELATED APPLICATIONS

This application claims the benefit of U.S. Provisional Application No. 61/119,104, filed Dec. 2, 2008, and German Patent application 10 2008 056 020.0, filed Nov. 5, 2008, both of which are incorporated herein by reference as if fully set forth.

### FIELD OF THE INVENTION

The present invention relates to a mechanical tensioning system that operates according to an eccentric principle and that can automatically pretension a traction mechanism of a traction mechanism drive. The tensioning system comprises a cylindrical carrier element that is allocated to a base plate and by which a fastening screw is guided, wherein the tensioning system can be detachably fastened with this fastening screw to a stationary machine part, in particular, a block of an internal combustion engine. The carrier element engages in a receptacle borehole of an eccentric bushing that is supported so that it can rotate via a sliding bearing and is pivoted into a position pretensioning the traction mechanism in the operating state by a torsion spring arranged between a stationary component of the tensioning system and the eccentric bushing. A track roller supported on the traction mechanism with a non-positive fit in the operating state is supported so that it can rotate by a roller bearing allocated to the eccentric bushing.

### BACKGROUND

The present invention extends, in particular, to tensioning systems designed for traction mechanism drives of internal combustion engines. A first traction mechanism drive of the internal combustion engine designated as an accessory drive is designed to drive individual accessories, such as air-conditioning compressors, water pumps, or generators. A second traction mechanism drive also designated as a timing drive or synchronous drive, drives at least one camshaft of the internal combustion engine. For this purpose, a belt, preferably a toothed belt is used as the traction mechanism that must always be adequately pretensioned in the operating state, in order to prevent slippage in the aggregate drive or tooth jumping in the timing drive. Tensioning systems acting preferably according to an eccentric principle are used for achieving adequate pre-tensioning.

Eccentric tensioning systems used today are comprised essentially of a base plate on which an eccentric bushing is arranged so that it can pivot. A torsion spring required for applying a tensioning force acts between the eccentric bushing and the base plate in that it is anchored between these components on the ends. The eccentric bushing is surrounded by a track roller that is arranged so that it can rotate by a roller bearing.

From DE 40 33 777 A1, an eccentric tensioning system is known that comprises an adjustment eccentric also designated as a carrier element with an integrated, eccentric longitudinal borehole that is designed for holding a fastening screw. The adjustment eccentric is supported in the installed state by a base plate on a machine part, in particular, a crankcase of the internal combustion engine and mounted detachably by the fastening screw. On the outside, the adjustment eccentric is surrounded by a work eccentric also designated as an operating eccentric, wherein a sliding bearing bushing is inserted into an annular gap between a lateral surface of the adjustment eccentric and an inner wall of the work eccentric. A roller bearing is positioned on the work eccentric, wherein this roller bearing is sealed on both sides of the roller body and has an outer ring with an associated track roller that interacts, in the operating state, directly or indirectly with a traction mechanism of the traction mechanism drive. For achieving a non-positive contact of the track roller on the traction mechanism, a torsion spring is used between the base plate and the operating eccentric, wherein this torsion spring charges the operating eccentric and the track roller connected to the operating eccentric permanently into a position tensioning the traction mechanism.

### SUMMARY

The object of the present invention is to create a component-optimized tensioning system that can be realized economically with improved damping that can also be used in an oily environment.

This objective is satisfied, according to the invention, by a tensioning system in which a leg-less, outwards opening, spreading torsion spring is integrated that is supported with one spring end on an advantageously star-shaped, divided cup packing arranged rotationally fixed on the base plate and simultaneously limited so that it can move in the radial direction. On the outside, the cup packing encloses at least partially a right-angled leg that interacts with at least one projection of the eccentric bushing projecting locally in the axial direction and enclosing the torsion spring. For forming a damping device, the right-angled leg is supported by the cup packing by means of an outer friction surface on an inner friction surface of the projection of the eccentric bushing.

With the construction according to the invention, an eccentric tensioning system with an increased damping force can be provided. Simultaneously, the design according to the invention in the eccentric tensioning system allows a tribological system to be realized with which adequate damping required for the function of the traction mechanism drive can be achieved also in an oily environment. Depending on the construction, the eccentric tensioning system according to the invention featuring improved damping can be used both for a dry environment and also for belt drives in which the belt circulates, for example, in some regions in an oil bath or in which the belt is exposed to an oil-containing environment. Furthermore, through the use of a leg-less torsion spring that can be produced economically, the assembly of the tensioning system according to the invention is simplified, in which the spring ends are supported, for example, on projections or recesses of the rotating eccentric bushing and the stationary cup packing The damping device according to the invention realizes improved, increased friction even in the case of an oil-wetted contact surface or in the case of fluid friction between the friction partners, the right-angled leg of the cup packing, and the projection of the eccentric bushing. The effective damping device that can be realized economically can be realized advantageously within the installation space of previously dry, non-lubricated eccentric tensioning systems. Furthermore, the invention offers the advantage that a nearly unchanged friction constant is set throughout the service life of the tensioning system.

Additional advantageous constructions of the invention are described in detail below.

According to one preferred construction of the invention, a friction coating is introduced into an annular gap limited by the projection of the eccentric bushing and the leg of the cup packing This friction coating constructed as a circular arc and fixed in position on one of the components, the projection of the eccentric bushing, or the leg of the cup packing is in active connection with the inner friction surface of the eccentric bushing or the outer friction surface of the cup packing. The friction coating can be allocated to any component. In addition, according to the invention, a friction coating made from the same or different materials could also be allocated to both the inner friction surface of the eccentric bushing and also the outer friction surface of the cup packing This arrangement has the effect that relative movement is realized between two friction materials for damping relative movements of the eccentric bushing relative to the cup packing Independent of the construction of the damping device, a material combination with which high damping can be generated and that further distinguishes itself through low wear is provided for the friction partners supported directly by a non-positive fit. The oil-resistant friction materials here also allow the use of waste oil, i.e., charging of the damping device with oil contaminated by soot particles or acids, without producing impermissibly high wear values.

Another design of the invention relates to sealing of the damping device with which it is effectively protected, in particular, from dust for use in a dry environment. For example, a gasket or O-ring is suitable that is inserted into an annular gap formed between the inner friction surface and the outer friction surface. The gasket preferably inserted into a groove is shaped or designed with tolerances so that this gasket is supported with a non-positive fit on both friction surfaces.

In the case of the use of the tensioning system according to the invention in an oily environment, preferably a seal-free damping device is suitable. For achieving improved oil feed or oil discharge, the projection of the eccentric bushing and/or the right-angled leg of the cup packing comprises at least one passage opening, by which, during continuous operation in an oily environment, an adequate lubricant supply to the damping device is guaranteed.

The construction of the tensioning system according to the invention further advantageously comprises a cup packing that is divided into sections or elements and on which one spring end of the torsion spring is supported. These cup packing elements are each rotationally fixed relative to the base plate and simultaneously allow radial displacement of the spring end according to the torsion spring spreading outwards in the case of a rotational load.

The construction of the tensioning system according to the invention can advantageously also be transferred to a double eccentric tensioning system. For this purpose, an eccentric longitudinal borehole designed for holding the fastening screw is created in the carrier element for forming an adjustment eccentric. The adjustable radial distance from the borehole center of the offset longitudinal borehole to a center of the tensioning system defines a first eccentric offset of the tensioning system that is adjustable for a basic setting of the tensioning system. The adjustment eccentric is surrounded by the eccentric bushing forming a work eccentric, by which it is set in the double eccentric tensioning system.

Another advantageous construction of the invention provides to arrange the torsion spring so that, under loading in the operating state and thus in a nominal position, the sliding bearing of the eccentric bushing is loaded at least essentially centrally. This measure prevents the introduction of a disadvantageous tilting moment into the sliding bearing that leads to an edge load on the sliding bearing and precludes uniform wear of the sliding bearing and also leads to the risk of tilting of the track roller.

Through the use of the leg-less torsion spring that can be loaded in the opening sense, the torsion moment is introduced as a tangential spring force via the stump-like spring ends into the eccentric bushing and into the stationary base plate. The introduction of the spring forces is set exactly geometrically by the support of the stump-like spring ends on the eccentric bushing or the base plate. The friction moment generated by the spring force about the rotational axis of the eccentric bushing and an equalizing tilting moment generated by the spring force about the tilting axis of the non-friction bearing can be influenced and/or adjusted by a variation of the diameter, the height, and the spring stiffness of the torsion spring without great expense.

The tensioning system according to the invention used in an oily environment furthermore requires no initial greasing of the damping device due to the measures of providing passage openings in the region of the cup packing and/or the eccentric bushing by which oil can enter into the damping device unimpaired.

Furthermore, it is possible to use a sliding bearing constructed as a multi-layer, sandwich, or solid-material sliding bearing in the tensioning system, wherein this sliding bearing can be advantageously combined with a wear-resistant surface of the carrier element and also a bearing play of ≦150 μm. In the tensioning system, while maintaining a known construction, this design allows the realization of a tribological system with which increased damping required for the function of the traction mechanism drive can be achieved in an oily environment. The construction of the sliding bearing according to the invention and representing an economical construction can advantageously be realized within the installation space of previously dry, non-lubricated sliding bearings of eccentric tensioning systems. The advantage of this multi-layer, sandwich, or solid-material sliding bearing lies especially in that friction consistency is created throughout the service life of the tensioning system and also a stick-slip-free re-adjustment behavior is set that is significant for the function of the tensioning system. The construction according to the invention and also the material combinations of the sliding bearing further distinguish themselves by low wear.

### BRIEF DESCRIPTION OF THE DRAWING

Additional advantageous measures of the invention will be described below in the description of a preferred embodiment. In a longitudinal section, the single FIGURE shows a tensioning system according to the invention constructed according to a simple eccentric principle.

### DETAILED DESCRIPTION OF THE PREFERRED EMBODIMENT

According to the sole FIGURE, the tensioning system 1 comprises a track roller 2 by which, in the operating state of the tensioning system 1, a tensioning force is applied onto a belt—not shown here. The track roller 2, preferably produced from plastic and mounted with a positive fit on an outer bearing ring 3 of a roller bearing 4, extends in the axial direction on both sides past the width of the roller bearing 4. An inner bearing ring 5 of the roller bearing 4 is positioned on a lateral surface 6 of an eccentric bushing 7. The eccentric bushing 7, also designated as a work eccentric, encloses a carrier element 8, wherein an annular gap limited in the radial direction by a lateral surface 9 of the carrier element 8 and a receptacle borehole 10 of the eccentric bushing 7 is designed for holding a sliding bearing 11. A central longitudinal borehole 12 of the carrier element 8 is designed for holding a not-shown fastening screw. Alternatively, it is possible to create a longitudinal borehole 12 offset in the radial direction to the center in the carrier element 8, by which the carrier element 8 can take over the function of an adjustment eccentric, by which the tensioning system 1 can be used as a double eccentric tensioning system. In the installed state, the tensioning system 1 is supported by a base plate 13 on a not-shown stationary machine part, in particular, the crankcase of an internal combustion engine and has a detachable arrangement using a fastening screw. The carrier element 8 is positionally fixed, for example, with a material fit on the base plate 13. A leg-less torsion spring 14 inserted between the base plate 13 and the eccentric bushing 7 charges the eccentric bushing 7 with a torsion moment, by which it is turned, in connection with the track roller 2, into a position pretensioning the traction mechanism. The torsion spring 14 is supported on each end by its stump-like spring ends advantageously with a positive fit on projections or recesses of the eccentric bushing 7 or on a stationary component allocated to the base plate 13. For the representation of the damping device 15, a cup packing 16 is allocated to the base plate 13, wherein a right-angled leg 18 is allocated to this cup packing on the outside locally, wherein this leg is surrounded by a projection 17 of the eccentric bushing 7 projecting in the axial direction. The outwards opening, spreading torsion spring 14 is supported with one spring end on the cup packing 16 divided into individual segments. The segments are each rotationally fixed and simultaneously mounted on the base plate 13 so that they have limited movement in the radial direction. In the operating state, a rotation of the eccentric bushing 7 into a position pretensioning the belt causes spreading of the torsion spring 14, by which the cup packing 16 or the associated segments are simultaneously shifted in the radial direction up until a leg 18 contacts the projection 17 of the eccentric bushing 7. Here, the leg 18 is supported by an outer friction surface on a corresponding inner friction surface of the projection 17 of the eccentric bushing 7. As an alternative to a direct support of these components, it is possible to introduce a friction coating 19 into an annular gap limited by the projection 17 and the leg 18, wherein this coating is positionally fixed, for example, on the inner contours of the projection 17. The damping device 15 is limited according to the embodiment to a partial position of the projection 17 and the leg 19 on the periphery. Alternatively, it is possible to provide the eccentric bushing 7 with a projection 17 that is closed on the periphery and that interacts with a similarly correspondingly shaped leg 18 of the cup packing 16. For achieving a sealed damping device 15, it is possible, for example, to arrange a seal or a sealing element on the projection 17 on the inside, wherein this seal is supported on the leg 18 of the cup packing 16. Furthermore, the tensioning system 1 can be designed for a belt drive used in an oily environment, wherein this drive is housed, for example, in a housing of an internal combustion engine closed on the end. All of the components of the belt drive have an oil-resistant construction. For example, the roller bearing 4 requires neither seals allocated to the roller bodies on the sides nor initial greasing before startup of the tensioning system 1. In addition, the projection 17 and/or the leg 18 of the cup packing 16 comprises at least one passage opening 20 that guarantees unimpaired oil feed and oil discharge to the damping device 15.

List of Reference Symbols

1 Tensioning system

2 Track roller

3 Bearing ring

4 Roller bearing

5 Bearing ring

6 Lateral surface

7 Eccentric bushing

8 Carrier element

9 Lateral surface

10 Receptacle borehole

11 Sliding bearing

12 Longitudinal borehole

13 Base plate

14 Torsion spring

15 Damping device

16 Cup packing

17 Projection

18 Leg

19 Friction coating

20 Passage opening

1. Mechanical tensioning system constructed according to an eccentric principle for a traction mechanism of a traction mechanism drive of an internal combustion engine, comprising a cylindrical carrier element allocated to a base plate adapted to receive a fastening screw for the tensioning system guided by the carrier element, the carrier element engages in a receptacle borehole of an eccentric bushing that is supported so that it can rotate by a sliding bearing, and a torsion spring is arranged between a stationary component of the tensioning system and the eccentric bushing and a roller bearing allocated to the eccentric bushing is surrounded on an outside thereof by a track roller, the torsion spring comprises a leg-less, outwards opening, spreading torsion spring, the eccentric bushing has at least locally a projection projecting in an axial direction and enclosing the torsion spring, a rotationally fixed cup packing that can shift to a limited extent in a radial direction and that forms at least partially a right-angled leg is positioned on the base plate, and for forming a damping device, the right-angled leg is supported by the cup packing by an outer friction surface on an inner friction surface of the projection of the eccentric bushing.

2. Tensioning system according to claim 1, wherein a friction coating is allocated to a component in an annular gap formed between the projection of the eccentric bushing and the leg of the cup packing

3. Tensioning system according to claim 1, wherein the damping device includes a seal.

4. Tensioning system according to claim 1, wherein the damping device is seal free and comprises at least one passage opening for an oil feed in at least one of the projection of the eccentric bushing or in the leg of the cup packing

5. Tensioning system according to claim 1, wherein the torsion spring is supported on a cup packing divided into sections, wherein the sections adapt to a radial displacement of a spring end of the torsion spring.

6. Tensioning system according to claim 1, wherein for forming an adjustment eccentric, the carrier element has an eccentric longitudinal borehole that forms, together with the eccentric bushing with the function of a work eccentric, a double eccentric tensioning system.

7. Tensioning system according to claim 1, wherein spring ends of the torsion spring are arranged so that, under load in a nominal position, the sliding bearing of the eccentric bushing is charged centrally or at least to a large extent without an edge load.

8. Tensioning system according to claim 1, wherein the tensioning system is started up without initial greasing of the damping device.

9. Tensioning system according to claim 1, wherein the sliding bearing encloses a wear-resistant surface comprises a multi-layer, sandwich, or solid material sliding bearing.
